(19) United States
(12) Patent Application Publication
(10) Pub. No.: US 2026/0186776 A1
(43) Pub. Date: Jul. 2, 2026

(54) SYSTEMS AND METHODS FOR EFFICIENT EXECUTION OF VECTOR OPERATIONS

(71) Applicant: Advanced Micro Devices, Inc., Santa Clara, CA (US)

(72) Inventor: Stuart David Simpson Biles, Cambridge (GB)

(73) Assignee: Advanced Micro Devices, Inc., Santa Clara, CA (US)

(21) Appl. No.: 19/005,946

(22) Filed: Dec. 30, 2024

(51) Int. Cl. G06F 9/30

(52) U.S. Cl. CPC G06F 9/3001; G06F 9/30025; G06F 9/30038

(57) ABSTRACT

A disclosed computer-implemented method may include loading a pair of input vectors of into a respective pair of registers included in a processor, each input vector associated with a different shared scale term. The method may also include storing a shared scale term corresponding to at least one of the pair of input vectors within at least one control register of the processor. The method may also include performing a vector operation that utilizes the pair of input vectors by accessing the at least one control register to retrieve the shared scale term as part of the vector operation Various other methods, systems, and computer-readable media are also disclosed.

### BACKGROUND

In the field of artificial intelligence (AI) and machine learning (ML), high computational efficiency and optimum use of memory hierarchy are of paramount importance. Traditional methods utilize number formats such as brain floating point 16-bit (bfloat16 or BF16) for vector dot product operations, supported by instruction set extensions like Advanced Vector Extensions 512 (AVX-512). However, these conventional systems have limitations, especially when handling emerging number formats such as MicroXcaling (MX), designed specifically for AI workloads. A key problem in these MX formats is the shared scale term associated with each input vector, which needs to be applied during vector operations like dot product operations. Applying the scale separately involves additional processing steps and temporary registers, which decreases the computational performance. Furthermore, a dot product operation which specifies two vectors of input, one predicate mask register, two sources of shared scale terms, and the destination accumulation vector, does not fit within the existing AVX-512 Extended Vector Extension (EVEX) prefix encoding framework. This presents a significant challenge in improving the compute density and efficiency of these workloads.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system 100 for efficient execution of vector operations.

FIG. 2 shows a structure of and components within a physical processor.

FIG. 3 is a flow diagram of an example computer-implemented method for efficient execution of vector operations.

FIG. 4 illustrates a view 400 of elements and a shared scale term in an MX format, designed to optimize the efficiency of numerical computations in AI and machine learning hardware.

FIG. 5 illustrates a table that describes a variety of formats proposed for the elements in MX formats.

FIG. 6 includes a code listing that represents a practical implementation of some of the systems and methods described herein.

FIG. 7 includes a code listing that represents a practical implementation of some of the systems and methods described herein.

FIG. 8 includes a code listing that represents a practical implementation of some of the systems and methods described herein.

FIG. 9 includes a code listing that represents a practical implementation of a dot product in accordance with some embodiments.

FIG. 10 includes a code listing that illustrates that the E8M0 encoding makes multiplication by shared scale terms effectively an exponent adjustment rather than a full multiplication.

FIG. 11 includes a code listing that demonstrates an optimized approach to handling a dot product operation for MX format data using the AVX-512 Instruction Set Architecture (ISA).

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for efficient execution of vector operations. As will be explained in greater detail below, embodiments of the instant disclosure introduce novel methods and systems that address the limitations of traditional technology by efficiently executing vector operations, particularly in the context of AI and machine learning workloads. This is accomplished through a process that includes loading a pair of input vectors into respective registers in a processor, storing a shared scale term within at least one control register, and performing a vector operation that utilizes the pair of input vectors. The shared scale term may be retrieved as part of the vector operation, circumventing the need for additional processing steps and temporary registers, thereby improving computational performance.

One aspect of the present disclosure involves a use of a processor's control registers, specifically the predicate mask registers and/or the processor state register(s). These registers have traditionally been used for conditional execution, data manipulation, and/or processor control. However, in this disclosure, they are repurposed to store the shared scale terms associated with the input vectors. This novel use of control registers not only reduces the number of operands required for the dot product operation but also enables the system to stay within the constraints of the AVX-512 encoding regime, a significant improvement over conventional methods.

The unique approach to handling shared scale terms and executing vector operations has a direct impact on improving the functioning of the computer itself. By streamlining the computation process, reducing the number of operands, and making better use of existing processor architecture, the invention enables faster and more efficient processing. This leads to improved performance, particularly in compute-intensive applications like AI and machine learning workloads.

Moreover, embodiments of the disclosure may significantly advance the field of digital signal processing and other technologies that rely heavily on efficient vector operations. By supporting newer, more compact number formats like MX formats, embodiments of the present disclosure may allow for higher compute density and better use of memory hierarchy. This can lead to substantial improvements in the speed and accuracy of machine learning models and image and audio processing algorithms, but also in Basic Linear Algebra Subprograms (BLAS) and other applications that rely on efficient vector computations.

An input vector may include a sequence of scalar elements that are processed collectively as a single entity in vector operations. Each scalar element within an input vector can be represented in a specified numerical format suitable for efficient computation in AI and ML workloads, such as the MX format. The input vector may be structured to align with an architecture of the processor's vector registers, allowing for parallel processing of the scalar elements within the vector. An input vector may have associated metadata, such as a shared scale term, which is applied during vector operations to normalize or scale the vector elements.

MicroXcaling is a specialized floating-point format engineered to optimize the performance of numerical computations by utilizing a shared scale term. Unlike traditional binary number representations such as bfloat16, the MX format employs a compact approach where a group of scalar elements within an input vector share a common scale term. This shared scale term, applied uniformly to all elements in the group, enables adjustments in magnitude and range without the need for individual scaling of each element. The design of MX formats is intended to significantly enhance memory usage and computational density, offering superior computational efficiency particularly in applications that require processing of large-scale numerical data sets. The shared scale term concept intrinsic to MX formats is a key differentiator that allows for reduced memory overhead and increased processing speed, thereby facilitating more efficient AI and machine learning computations.

Advanced Vector Extensions (AVX) is a set of instruction set extensions designed to enhance performance for applications that require high computation, such as scientific simulations, financial analytics, artificial intelligence, data compression, and so on. AVX uses single instruction, multiple data (SIMD) operations, which allow multiple data points to be processed simultaneously with a single instruction. AVX architecture is characterized by wider vector registers (up to 512-bits wide in AVX-512), more data lanes for parallel computations, and a rich set of instructions for diverse types of data.

Embodiments of this disclosure may address a challenge inherent to the MX formats when they are used in dot product operations-particularly those similar to VDPBF16PS, which is an instruction in the AVX-512 instruction set that performs a dot product of BF16 packed vectors with accumulation in single-precision floating-point format.

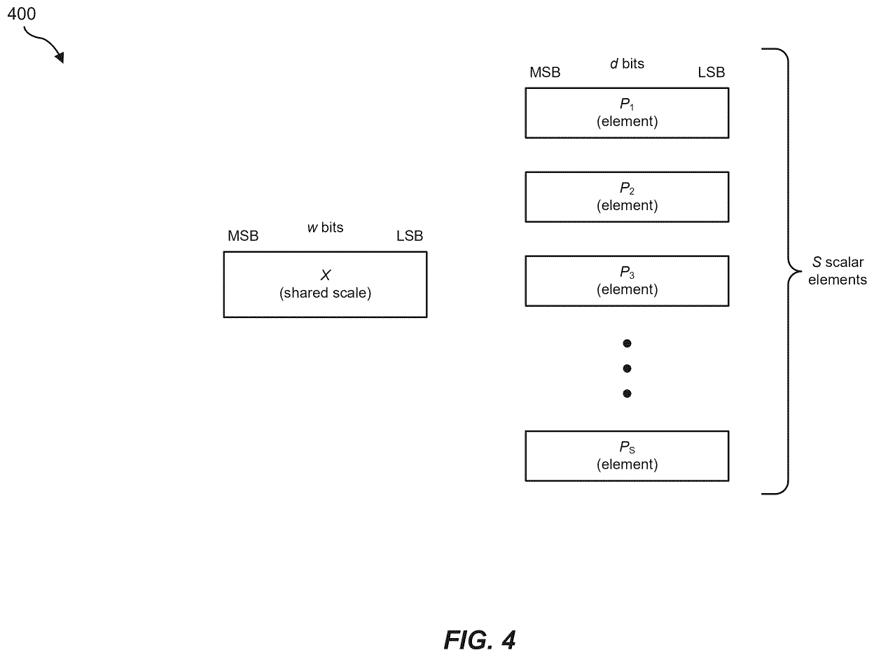

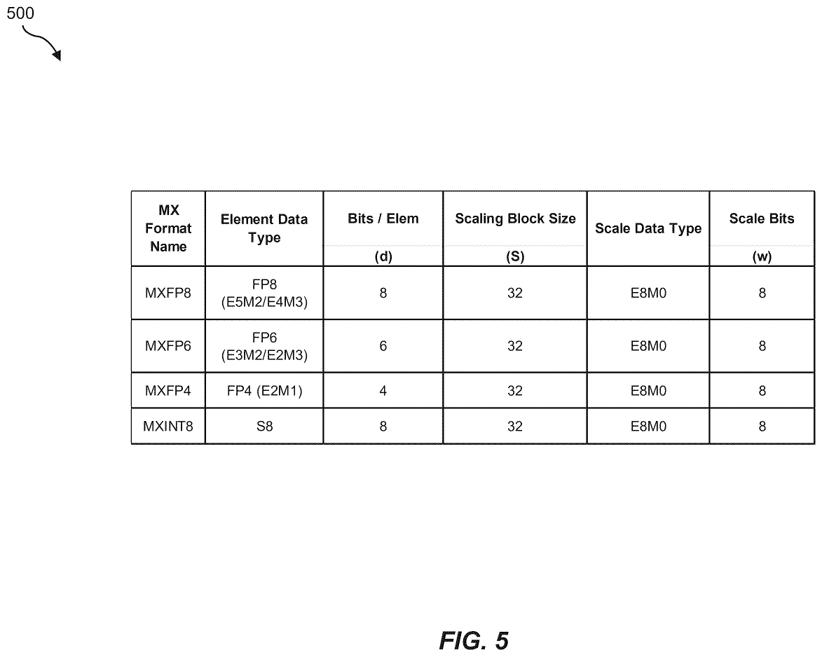

In such operations, as described below in greater detail below in reference to FIG. 4 and FIG. 5, each input vector, typically composed of a block of elements, has an associated scale term that needs to be applied during the dot product operation. While some current specifications may use a minimum block size (e.g., 32 elements), in principle, a different (e.g., smaller or larger) block size could be used. Conventionally, this scaling operation has to be executed separately, which introduces additional processing steps and requires the use of temporary registers. These additional requirements may negatively impact computation performance.

A potential solution could be a dot product operation similar to VDPBF16PS, but one that also specifies two sources of shared scale terms in addition to the two input vectors, one predicate mask register, and the destination accumulation register. However, such an instruction footprint would be too large and would not fit within the AVX-512 EVEX prefix encoding framework, which is a specific encoding scheme used for certain AVX-512 instructions.

The AVX-512 ISA already includes dot product primitives for BF16 and integer data types, such as the VDBBF16PS instruction. This instruction allows for the multiplication of pairs of BF16 format data and accumulation of the results into FP32 destination lanes. This process involves loading 512 bits of BF16 input into vectors and performing dot product operations, which spread the result across multiple FP32 lanes. While horizontal summation across the vector can be used in some instances to obtain a final result, there are different ways to use the dot product instruction, for example by using the embedded broadcast functionality available with AVX-512. Other methods may also be employed to avoid or optimize this summation step.

To leverage the increased storage and computational density offered by MX formats, which are more compact than BF16, a similar operation to VDBBF16PS is needed. For instance, the MXFP8 format is half the size of BF16, and MXFP4 is even more compact. The ideal scenario would involve a 512-bit vector operation consuming MX format data and accumulating directly into an FP32 results vector. Using MXFP8 as an example, a 512-bit vector can contain two MX blocks of 32-element MXFP8 data, each associated with a shared scale term. A naïve dot product operation would involve loading these MXFP8 elements and performing the dot product while considering the scale terms.

However, expressing this operation within the AVX-512 encoding constraints poses significant challenges. The example given illustrates a dot product operation with six operands, including the destination accumulator, a predicate mask register, two input MX vectors, and their respective scale terms. This complexity makes it impractical to fit such an instruction within the current AVX-512 encoding regime. Furthermore, it is unrealistic to have a single instruction reading six register values, especially if the instruction is designed to be efficient and executed within a few cycles.

A challenge addressed by this disclosure may not be the complexity of the data processing operation itself. Instead, an issue lies in the number of operands needed to perform the operation. For MXFP8 format data, each 512-bit input vector may require two 8-bit scale terms, resulting in 32 bits of scales for a dot product. For MXFP4 format data, this increases to 64 bits of shared scale terms for two 512-bit input vectors. Therefore, a dot product operation template similar to VDPBF16 that fits within the AVX-512 instruction encoding framework is needed to effectively utilize MX formats.

Embodiments of the present disclosure, therefore, aim to allow the desired dot product operation while still complying with the constraints imposed by the AVX-512 architecture and the EVEX prefix encoding. By doing so, embodiments can enhance the efficiency and performance of MX format operations by reducing the need for additional processing steps and temporary registers.

The present disclosure is generally directed to systems and methods that may expand the use of control registers (e.g., predicate mask registers and/or a processor state register) to contain the shared scale terms. In the AVX-512 instruction set architecture, the predicate mask registers are 64-bits in width, sufficient to indicate a predicate for every byte within a 512-bit vector. This approach may reduce a number of operands required for the MX dot product operation from six to four, thus fitting within the existing AVX-512 instruction encoding framework.

The present disclosure may illustrate this with an example in which the predicate mask register is used to store the shared scale terms for two input vectors. This allows the dot product operation to specify a destructive source/destination, a mask, and two vector sources, which is in line with the encoding footprint of existing AVX-512 instructions.

The present disclosure also describes an alternate way to handle vector operations (e.g., dot product operations) involving MX format data. Instead of requiring multiple processing steps and temporary registers to apply the shared scale terms, some embodiments of this disclosure may use an implicit processor state to contain the shared scale terms, reducing the number of operands in the dot product operation.

The term “implicit” in this context may indicate that the processor state (in this case, the shared scale terms for the dot product operation) may not be explicitly provided as an operand in the instruction. Instead, it may be stored in a dedicated location (like a process state register) and the instruction implicitly knows to fetch the information from the dedicated location when executing the dot product operation.

The use of processor state to handle shared scale terms implicitly may sidestep the encoding constraints of the AVX-512 instruction set. This may allow for an efficient dot product operation similar to VDPBF16 to be used with MX format data, potentially improving computation performance.

As will be described in greater detail below, this solution may also introduce new intrinsics, such as _scale64_genscales and _mm512_dpe5m2e5m2_ps. These intrinsics respectively combine scale terms into a processor state register and perform a quad-wise dot product using the scale data in the processor state register. A variety of permutations may be considered in this context. For instance, the mask register may contain just predicate bits or could be repurposed to contain just scale values. Additionally or alternatively, the mask register may contain both predicate bits and scale values, where these are arranged to be in non-overlapping parts of the mask register. Moreover, the _scale64_genscales operation could be employed not only to combine scales in advance of conversion operations, but also to format the scale and merge it into a mask register, either with the scale values alone or combined with predicate bits. The functionality of the dot product operation _mm512_dpe5m2e5m2_ps is a floating point equivalent of the VPDPBUSD (Multiply and Add Unsigned and Signed Bytes) instruction present in AVX-512. Instead of consuming two vectors of integer byte values, the floating point dot product consumes two vectors of FP8 E5M2 values and accumulates into FP32 results. In relation to dot product operations that consume a scale, it is possible to have a separate or combined scale for each block of 32 inputs, potentially up to 2×2 scales for FP8. It is also possible to have a single scale, which could be one from each input vector or a combined version thereof, that applies to the entire dot product operation. The functionality performed by these intrinsics may be achieved by a sequence of existing instructions or further optimized by the introduction of new instructions that combine some or all of the steps outlined above.

While this approach may introduce an additional instruction step to set the shared scale term, it optimizes the combining of the two scale streams. The overhead can be mitigated if the shared scale terms are common across several MX format blocks Furthermore, this approach allows for flexibility in the use of the predicate mask registers. In one option, they could still be made to apply to dot product operations to zero/mask output lanes in line with other predicated AVX operations. In another option, with the joint predicate/scale configuration noted earlier, it is also possible to perform both predication and scaling with a single predicate register.

This approach may retain much of the coding style used with BF16 operations while leveraging a denser numerical format for more efficient computation.

Furthermore, the present disclosure may also describe various methods for converting between MX- and AVX-compatible formats.

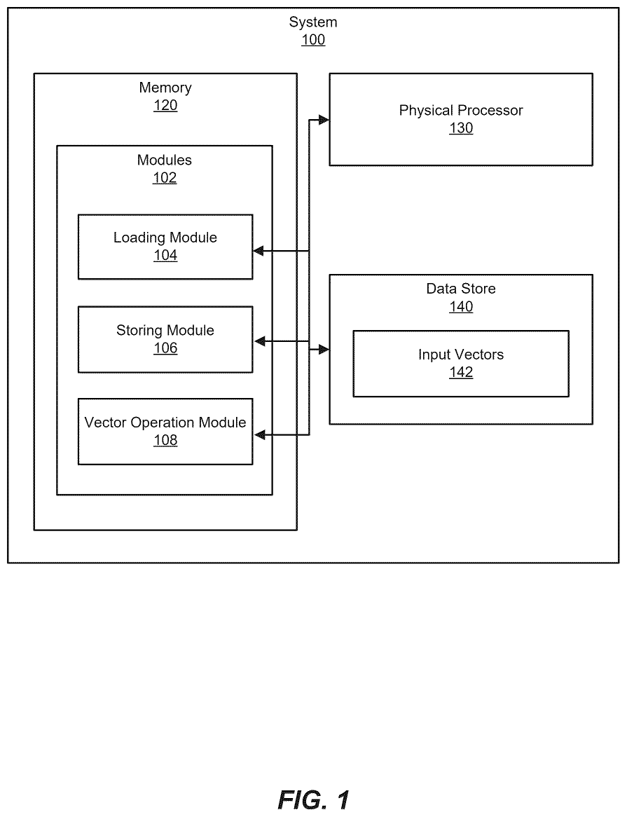

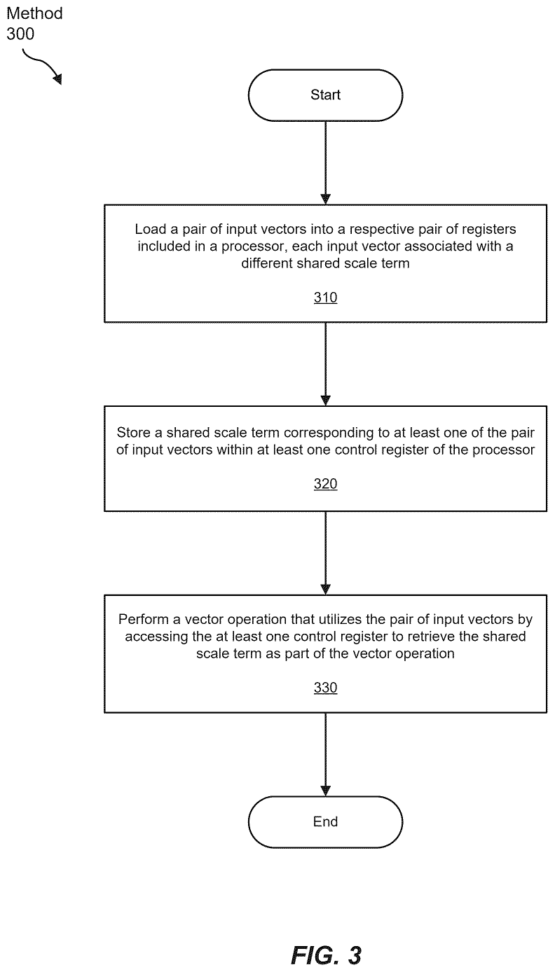

The following will provide, with reference to FIGS. 1-2 and 4-10, detailed descriptions of systems for efficient execution of vector operations. Detailed descriptions of corresponding computer-implemented methods will also be provided in connection with FIG. 3.

FIG. 1 is a block diagram of an example system 100 for efficient execution of vector operations. As illustrated in this figure, example system 100 may include one or more modules 102 for performing one or more tasks. As will be explained in greater detail below, modules 102 may include a loading module 104 that loads a pair of input vectors into a respective pair of registers included in a processor. Each input vector may be associated with a different scale term. In other words, a first input vector may be associated with a first shared scale term, and a second input vector may be associated with a second shared scale term. Example system 100 may also include a storing module 106 that may correspond to at least one of the pair of input vectors within at least one control register of the processor. As described above, in some examples, the control register may be or include a predicate mask register. In additional examples, the control register may be or include a processor state register, or any other suitable control register within the processor.

As shown, example system 100 may also include a vector operation module 108 that may perform a vector operation, such as a dot product operation, that utilizes the pair of input vectors by accessing the control register to retrieve the shared scale term as part of the vector operation.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

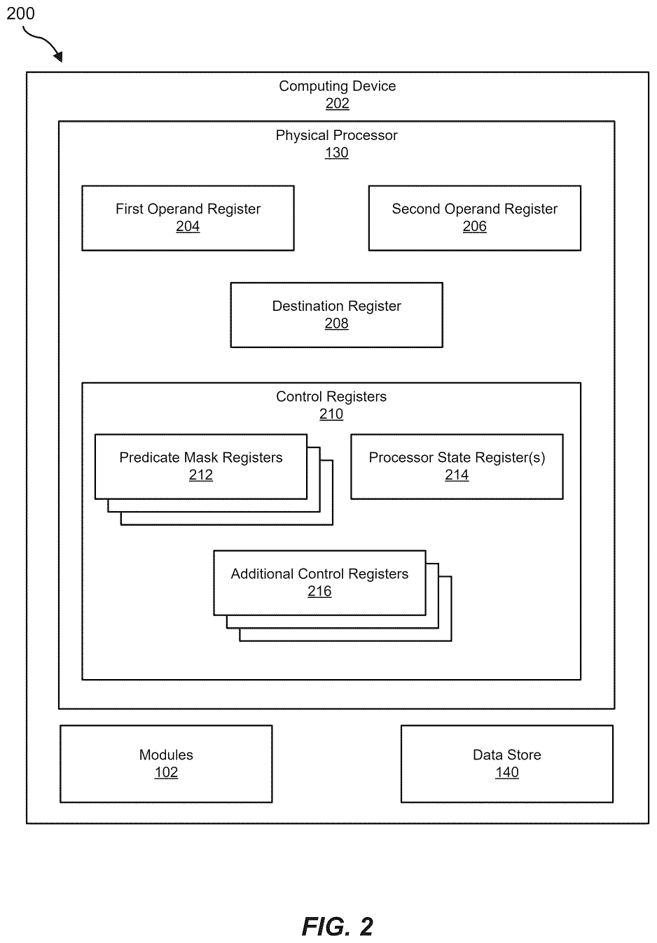

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate efficient execution of vector operations. Examples of physical processor 130 include, without limitation, microprocessors, microcontrollers, central processing units (CPUs), graphics processing units (GPUs), Field-Programmable Gate Arrays (FPGAs) that implement softcore processors, Application-Specific Integrated Circuits (ASICs), portions of one or more of the same, variations or combinations of one or more of the same, or any other suitable physical processor. Additional details of physical processor 130 may be provided below in reference to FIG. 2.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, etc.). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

As further shown in FIG. 1, data store 140 may also include, store, maintain, or have access to input vectors 142. Input vectors 142 may include or represent any data that may be processed by system 100 including, but not limited to, input vectors to be used in vector operations executed by physical processor 130, the shared scale terms associated with the input vectors. In some examples, although not shown in FIG. 1, data store 140 may additionally include, store, maintain, and/or have access to other related data used or generated by the system, such as configuration data, logs, metadata, and/or results of vector operations.

Example system 100 in FIG. 1 may be implemented in a variety of ways. For example, all or a portion of example system 100 may represent portions of an example system 200 (“system 200”) in FIG. 2. As shown in FIG. 2, system 200 may include computing device 202. In at least one example, computing device 202 may include physical processor 130, may be programmed with one or more of modules 102, and may include and/or have access to data store 140.

FIG. 2 shows a structure of and components within a physical processor 130. In some examples, physical processor 130 may include or represent a physical processor that supports the AVX-512 ISA. Therefore, physical processor 130 may be capable of performing 512-bit wide vector operations and may include the necessary hardware to execute AVX-512 instructions efficiently.

As shown, physical processor 130 includes a first operand register 204 and a second operand register 206. Operands in this context may include or represent data that the processor operates on. In the context of a processor that supports the AVX-512 instruction set, first operand register 204 and second operand register 206 may each include or represent one of the ZMM registers in AVX-512. The ZMM registers are 512-bit wide registers used to store operands for vector operations. AVX-512 provides 32 ZMM registers (ZMM0 to ZMM31).

Physical processor 130 also includes a destination register 208. In general, this register may be used to store a result of an operation performed by the processor. Within the AVX-512 ISA, the XMM, YMM or ZMM registers may store the result of an AVX-512 operation. In some vector operations, such as multiply accumulate operations, the destination register 208 may also provide a third source operand to the vector operation.

As shown, physical processor 130 also includes a group or set of control registers 210. Control registers 210 may include or represent a collection of registers that control the operation of the processor. These registers typically store information like control flags, mode settings, and status information. Within the AVX-512 ISA, control registers 210 may include various registers that control the execution of AVX-512 instructions. As will be described in greater detail below, one or more embodiments of the systems and methods described herein may repurpose one or more of control registers 210 to enable efficient execution of vector operations.

Control registers 210 may include predicate mask registers 212. These registers are used to hold predicate masks, which are used in conditional operations to determine whether certain instructions should be executed or not. AVX-512 introduces eight 64-bit opmask registers (k0 to k7) used for masking operations. These registers allow selective enabling or disabling of operations on elements within the vector registers, providing fine-grained control over vector computations.

Control registers 210 may also include one or more processor state register(s) 214. In general, this register may hold information related to the state of the processor, including information about the current operation, status flags, and other critical state information needed to manage the processor's activity. Within the AVX-512 ISA, this may include registers like the EFLAGS register, which holds the state of the processor and includes flags that affect the outcome of operations. Additionally or alternatively, this may include the MXCSR (control and status register) which controls the SIMD floating-point unit and handles floating-point exceptions. It may also include other state registers necessary for managing the execution context of AVX-512 instructions.

As shown, physical processor 130 may include various additional control registers 216. These registers may provide additional control and configuration settings for the processor, complementing the primary control registers. In the AVX-512 ISA, these registers may provide additional configuration and control settings specific to AVX-512 features. They might include registers that manage specific aspects of the AVX-512 extensions, such as enabling or disabling certain features or handling advanced performance settings.

In at least one embodiment, one or more modules 102 from FIG. 1 may, when executed by physical processor 130 (or another suitable processor), may enable physical processor 130 (or another suitable processor) to perform one or more operations to enable efficient execution of vector operations. For example, as will be described in greater detail below, loading module 104 may cause one or more physical processors (e.g., physical processor 130 or another suitable processor) to load a pair of input vectors (e.g., from input vectors 142) into a respective pair of registers included in a processor (e.g., first operand register 204 and second operand register 206), each input vector associated with a different shared scale term.

Furthermore, storing module 106 may cause one or more physical processors (e.g., physical processor 130 or another suitable processor) to store a shared scale term corresponding to at least one of the pair of input vectors within at least one control register of the processor (e.g., control registers 210). In at least one example, storing module 106 may store the shared scale term corresponding to at least one of the pair of input vectors by loading the shared scale term associated with a first of the pair of input vectors into a first predicate mask register (e.g., one of predicate mask registers 212) and loading the shared scale term associated with a second of the pair of input vectors into a second predicate mask register (e.g., another one of predicate mask registers 212). In an additional example, storing module 106 may cause physical processor 130 to store the shared scale term corresponding to at least one of the pair of input vectors in a processor state register (e.g., processor state register 214). In some examples, storing module 106 may cause physical processor 130 to store one or both of the associated shared scale terms in the processor state register 214. In further examples, storing module 106 may cause physical processor 130 to store a first one of the shared scale terms in the processor state register 214, and a second one of the shared scale terms in at least one of additional control registers 216.

Moreover, vector operation module 108 may cause one or more physical processors (e.g., physical processor 130 or another suitable processor) to perform a vector operation that utilizes the pair of input vectors by accessing the at least one control register (e.g., control registers 210, such as predicate mask registers 212 and/or processor state register(s) 214) to retrieve the shared scale term as part of the vector operation. In some examples, vector operation module 108 may cause physical processor 130 to perform the vector operation by accessing a single predicate mask register, which has combined the shared scale terms associated with both input vectors, as part of a dot product operation. Additionally or alternatively, in some instances, the storing module 106 may cause physical processor 130 to perform the vector operation by defining a dot product operation to implicitly access the shared scale term from the processor state register as part of the dot product operation. In still further examples, one or more of modules 102 may use two mask registers, one for each of the input vectors.

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

In at least one example, computing device 202 may be a computing device programmed with one or more of modules 102. All or a portion of the functionality of modules 102 may be performed by computing device 202 and/or any other suitable computing system. As will be described in greater detail below, one or more of modules 102 from FIG. 1 may, when executed by at least one processor of computing device 202, may enable computing device 202 to enable efficient execution of vector operations.

Many other devices or subsystems may be connected to system 100 in FIG. 1 and/or system 200 in FIG. 2. Conversely, all of the components and devices illustrated in FIGS. 1 and 2 need not be present to practice the embodiments described and/or illustrated herein. The devices and subsystems referenced above may also be interconnected in different ways from those shown in FIG. 2. Systems 100 and 200 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 3 is a flow diagram of an example computer-implemented method 300 for efficient execution of vector operations. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may load a pair of input vectors into a respective pair of registers included in a processor, each input vector associated with a different shared scale term. For example, loading module 104 may, as part of computing device 202, cause physical processor 130 to load a first input vector into first operand register 204 and a second input vector into second operand register 206. Each input vector may be associated with a different shared scale term.

In some examples, each of the pair of input vectors may be represented in an MX format. As mentioned above, MX formats are specialized numerical representations used in AI and ML hardware to optimize computational efficiency and precision. These formats often involve reduced precision, such as 8-bit, 6-bit, and 4-bit formats, to accelerate computations and reduce power consumption. One of the key techniques in MX formats is the use of shared scale terms. Instead of each number having its own large exponent, groups of numbers share a common scale term and each number has its own reduced size exponent. This approach allows for more compact data representation and simplifies hardware design, leading to faster processing and lower energy requirements.

FIG. 4 illustrates a view 400 of elements and a shared scale term in an MX format, designed to optimize the efficiency of numerical computations in AI and machine learning hardware. The figure shows a set of S scalar elements, labeled as P₁, P₂, P₃, . . . , P_{S}, each represented using d bits. These elements are grouped together and share a common scale term X, which is represented using w bits. The shared scale term X is stored separately from the individual scalar elements and provides a common exponent for all the elements within the group.

The use of a shared scale term allows for more efficient data representation and processing by minimizing the number of scale bits needed for each element. This structure ensures that all scalar elements P₁ to P_{S} are scaled uniformly, facilitating efficient vectorized operations. The Most Significant Bit (MSB) and Least Significant Bit (LSB) labels on both the shared scale term and the scalar elements indicate the bit structure, emphasizing the precision and range of the numerical values.

Overall, the arrangement depicted in FIG. 4 exemplifies how MX formats leverage shared scale terms to enhance computational performance and precision. By storing a single shared scale term for multiple scalar elements, this format reduces memory overhead and computational complexity, enabling faster and more power-efficient processing in AI and machine learning applications.

FIG. 5 illustrates a table 500 that describes a variety of formats proposed for the Pᵢ elements in MX formats. The table categorizes different MX formats by their names, element data types, bits per element (d), scaling block sizes (S), scale data types, and scale bits (w). Each format is tailored to balance precision and computational efficiency for different AI and machine learning applications.

The table includes four MX formats: MXFP8, MXFP6, MXFP4, and MXINT8. The MXFP8 format uses FP8 (8-bit floating-point) elements with two possible configurations, E5M2 and E4M3, providing a good trade-off between dynamic range and precision. Note that, in the syntax of ExMy, x indicates a number of exponent bits and y indicates a number of mantissa bits. As shown, each element in MXFP8 is 8 bits, with a scaling block size of 32 elements, and uses an E8M0 scale data type with 8 scale bits. Similarly, MXFP6 and MXFP4 utilize FP6 (6-bit floating-point) and FP4 (4-bit floating-point) elements, respectively, with varying configurations of exponent and mantissa bits to fit different precision requirements while maintaining the same scaling block size and scale data type as MXFP8. MXINT8, on the other hand, uses S8 (8-bit signed integer) elements, also with a scaling block size of 32 and an E8M0 scale data type, providing an integer-based alternative with 8 scale bits.

This structured approach to defining the formats ensures flexibility and adaptability in MX applications, allowing the selection of the most appropriate format based on the precision and computational efficiency needed for specific tasks. By standardizing the scaling block size and scale bits across these formats, the table facilitates easy integration and interchangeability within AI and machine learning hardware systems.

Blocks of MX data are primarily intended to be consumed into dot product operations that are used to synthesize matrix multiplications. The equation provided below defines the dot product C of two vectors A and B in MX format. The dot product C is computed as follows:

$$C = Dot ( A , B ) = {X}^{( A )} {X}^{( B )} ( {\sum }_{i = 1}^{k} ( {P}_{i}^{( A )} \times {P}_{i}^{( B )} ) )$$

In this equation, X^{(A)} and X^{(B)} represent the shared scale terms for the vectors A and B, respectively. The summation term

$${\sum }_{i = 1}^{k} ( {P}_{i}^{( A )} \times {P}_{i}^{( B )} )$$

represents the element-wise products of the scalar elements Pᵢ from each vector, summed over the index i from 1 to k, where k denotes the number of elements in each vector.

The result C is defined as a single precision FP32 (32-bit floating-point) value, ensuring compatibility with standard numerical precision used in many AI and machine learning frameworks. The internal precision of the dot product operation is specified as implementation-defined, meaning that it can vary depending on the hardware or software implementation. This allows for flexibility in optimizing performance and precision based on the specific requirements of the computational environment. In the definition provided, the shared scale terms X^{(A)} and X^{(B)} for both input vectors have been factored out of the summation term, highlighting the efficiency of the MX format in handling large-scale matrix operations by reducing redundant computations and facilitating parallel processing. The shared scale term may be applied to a summation term prior to an accumulation during the vector operation.

In some examples, first operand register 204 and/or second operand register 206 may be configured to be used in vector operations in accordance with the AVX-512 instruction set. AVX-512 registers may not be configured to store or otherwise handle shared scale terms of MX formats. Therefore, in the context of storing elements of an MX format value in an AVX-512 operand register, the scalar elements Pᵢ may be efficiently packed into the register while the shared scale terms are managed separately, as described herein. As mentioned above, AVX-512 provides 512-bit wide registers that can hold multiple scalar elements simultaneously, facilitating high-throughput vectorized computations. For instance, in the case of the MXFP8 format, where each element is 8 bits, an AVX-512 register can store up to 64 such elements, allowing for substantial parallel processing capabilities.

Each AVX-512 register may be divided into 16 lanes, each 32 bits wide, accommodating different configurations of the MX format elements. For example, when storing MXFP8 elements, the register is packed with consecutive 8-bit elements from P₁ to P₆₄. This approach maximizes the use of the register's capacity and leverages the AVX-512 instruction set for parallel operations, such as addition, multiplication, and other arithmetic functions, across all elements in a single instruction cycle. The scalar elements are stored in a contiguous block within the register, ensuring efficient access and manipulation during computations.

Returning to FIG. 3, at step 320, one or more of the systems described herein may store a shared scale term corresponding to at least one of the pair of input vectors within at least one control register of the processor. For example, storing module 106 may cause physical processor 130 to store a shared scale term corresponding to the first input vector, the second input vector, or both input vectors, within respective predicate mask registers 212, processor state register(s) 214, and/or additional control registers 216.

Continuing with the above illustration, the shared scale terms (X), which provide a common exponent for the group of scalar elements, are stored separately within a control register (e.g., any of control registers 210). This arrangement simplifies the hardware design and enhances computational efficiency. The common scale term is accessed only when necessary, ensuring that the AVX-512 registers are utilized optimally for high-performance parallel processing tasks in AI and machine learning applications.

Hence, at step 330, one or more of the systems described herein may perform a vector operation that utilizes the pair of input vectors by accessing the at least one control register to retrieve the shared scale term as part of the vector operation. For example, vector operation module 108 may cause physical processor 130 to perform a vector operation that utilizes the first input vector, loaded into first operand register, and the second input vector, loaded into the second operand register. The vector operation may be any suitable vector operation including, but not limited to, a dot product operation.

Vector operation module 108 may cause physical processor 130 to access the control register 210 (e.g., one or more of predicate mask registers 212 and/or processor state register(s) 214) to retrieve the shared scale term as part of the vector operation.

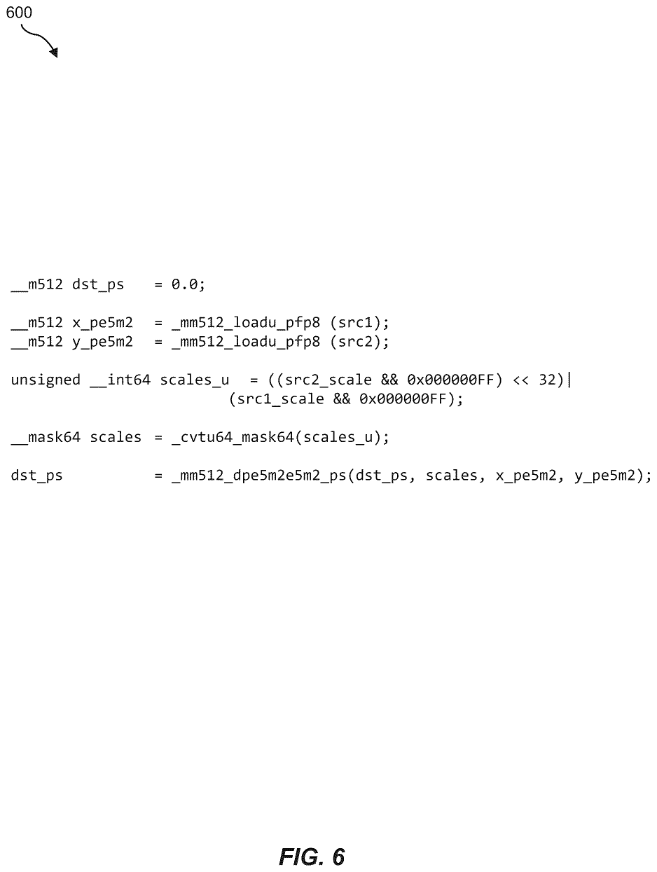

FIG. 6 includes a code listing 600 that represents a practical implementation of some of the systems and methods described herein. The first line initializes a vector of single precision floating point numbers (dst_ps) with zeros. This vector will be used to store the result of the dot product operation.

The next two lines load two 512-bit vectors (x_pe5m2 and y_pe5m2) from the respective source locations (src1 and src2). These vectors contain the elements of the MX format data that will be used in the dot product operation.

The fourth line constructs a 64-bit unsigned integer (scales_u) that combines the shared scale terms for the two MX format blocks. The shared scale term for src2 is shifted 32 bits to the left and combined with the scale term for src1 using a bitwise OR operation. The bitwise AND operation with 0x000000FF ensures that only the least significant byte of each scale term is used.

The fifth line converts this unsigned integer into a mask (scales) using the _cvtu64_mask64( ) function. This mask contains the shared scale terms that will be used in the dot product operation.

The final line performs the dot product operation with the _mm512_dpe5m2e5m2_ps( ) function. This function takes as input the initialized vector dst_ps, the mask scales, and the two loaded vectors x_pe5m2 and y_pe5m2. The result of the dot product operation is stored back into dst_ps.

This listing illustrates how embodiments of the systems and methods disclosed herein may optimize the operation by exploiting the predicate mask registers in the AVX-512 ISA to store the shared scale terms, reducing the number of operands for the MX dot product operation and keeping the encoding footprint in line with existing AVX-512 instructions. The resultant code retains the same style as BF16 code, but allows for direct computation using a denser numerical format.

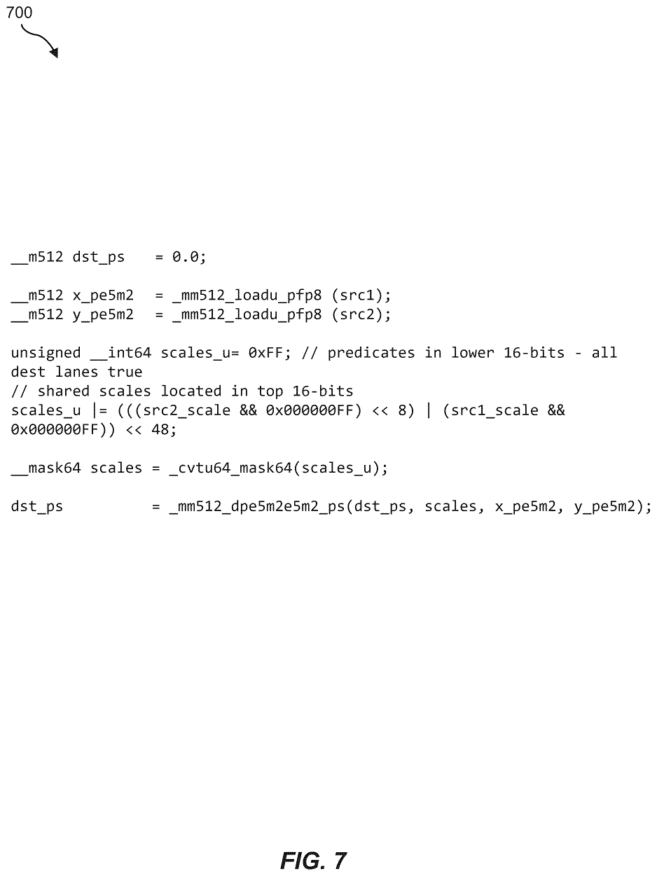

FIG. 7 includes an additional code listing 700 that represents a practical implementation of some of the systems and methods described herein, particularly demonstrating a use case where shared scale terms are placed higher up in the mask64 register.

The first line initializes a vector of single precision floating point numbers (dst_ps) with zeros, same as in the previous code listing. This vector will be used to store the result of the dot product operation.

The next two lines load two 512-bit vectors (x_pe5m2 and y_pe5m2) from the respective source locations (src1 and src2). These vectors contain the elements of the MX format data that will be used in the dot product operation.

The fourth line initiates an unsigned 64-bit integer (scales_u) with a value of 0xFFFF. This represents that all destination lanes are true, in the bottom 16-bits of the mask register, which are conventionally used for predication in AVX512 operations.

The shared scale terms are then placed in the top 16-bits of the mask register. The shared scale term for src2 is shifted 8 bits to the left and combined with the scale term for src1 using a bitwise OR operation. The result is then shifted left by 48 bits and combined with scales_u using a bitwise OR operation. The bitwise AND operation with 0x000000FF ensures that only the least significant byte of each scale term is used.

The fifth line converts this unsigned integer into a mask (scales) using the _cvtu64_mask64( ) function. This mask contains the shared scale terms that will be used in the dot product operation, and also retains the bottom 16-bits for conventional predication.

The final line performs the dot product operation with the _mm512_dpe5m2e5m2_ps( ) function. This function takes as input the initialized vector dst_ps, the mask scales, and the two loaded vectors x_pe5m2 and y_pe5m2. The result of the dot product operation is stored back into dst_ps.

In the code listing 700, the bottom 16-bits of the mask register are used for conventional predication, indicating whether each lane (or data element) in the vector should participate in the operation. This is accomplished by initializing the unsigned 64-bit integer, scales_u, with a value of 0xFFFF, meaning all lanes are true or ‘enabled’. In cases where not all lanes should contribute to the result of the operation, a different mask value may be used.

Following that, the shared scale terms are placed in the higher bits of the mask register (starting from bit 48). This allows the dot product operation to not only support lane predication (using the lower 16-bits of the mask register), but also apply the shared scale terms to the intermediate results of the operation (using the higher bits of the mask register).

This setup of the mask register allows the _mm512_dpe5m2e5m2_ps( ) function to perform the dot product operation with both lane predication and scaling. The function will only operate on the lanes where the corresponding predicate bit is true, and it will apply the appropriate shared scale term to the intermediate results of these lanes. This adds flexibility and efficiency to the operation, allowing for more precise control over the computation and potentially reducing unnecessary calculations.

This listing illustrates how embodiments of the systems and methods disclosed herein can enable both masking and scaling by leaving the bottom 16-bits of the mask register as is and placing the scales in a higher bit position of the mask register. This maintains the conventional use of mask register for predication, while enabling application of shared scale.

In some embodiments, one or more of modules 102 may further combine the shared scale terms associated with the pair of input vectors into a combined shared scale term. The combined shared scale term may then be formatted to ensure compatibility with the control register in which it will be stored. Depending on the specific implementation, the combined shared scale term may be placed in a single predicate mask register or stored into a general register. The choice between these options could be based on factors such as the size of the combined shared scale term, the available registers, and the specific requirements of the vector operation to be performed. When vector operation module 108 performs the vector module, it utilizes the pair of input vectors by accessing either the single predicate mask register or the general register to retrieve the combined shared scale term as part of the vector operation. This allows the system to streamline the vector operation by reducing the number of registers that need to be accessed.

As mentioned above, in some embodiments, shared scale terms may be implicitly read from the processor state, thereby removing any requirement or pressure on the dot product instruction to specify which state should be read for the scale terms.

Assuming that a new state is introduced in a processor state register (e.g., processor state register(s) 214), a 64-bit register would be large enough to hold two vectors of scale terms each for four blocks of MXFP4 format data. The layout of this register could be varied: it could be split into 32-bits each for vector 1 and vector 2; it could combine 8-bit scale terms, pre-combined result of the corresponding element in vector 1 and vector 2, requiring only 32-bits to cover a 512-bit MXFP4 dot product; or it could combine into 9-bit scale terms, preserving a bit of range until the dot product result is computed. Additionally, if space permits, the field could be located in a previously unused portion of an existing processor state register.

By containing the shared scale terms in this implicit state, the number of operands specified to the MX dot product operation can be reduced from six to four. This encompasses two source vectors, one destination vector, and one mask register instead of an additional two scale operands. The dot product operation specifies a destructive source/destination (dst_ps), and two vector sources, which is consistent with existing AVX-512 instructions. Although this approach introduces an additional instruction step to set the shared scale term in DP_SCALES, the overhead can be mitigated if the shared scale terms are common across several MX format blocks. In such a case, the scale would only need to be set once for the larger calculation spanning multiple MX blocks. This approach retains the coding style of the BF16 example, but with the advantage of direct computation using a denser numerical format.

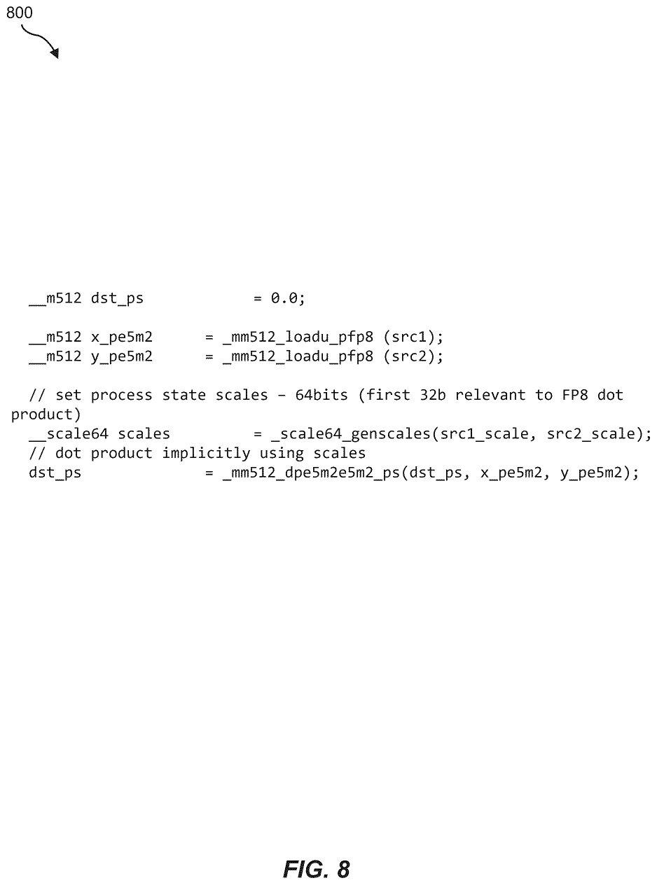

FIG. 8 includes a code listing 800 that represents a practical implementation of some of the systems and methods described herein. The code describes a process of performing a dot product operation using shared scale terms that are implicitly read from the processor state, allowing for a reduction in the number of operands required. The process begins with the initialization of a 512-bit destination vector dst_ps, set to 0.0. This vector is designated to accumulate the results of the subsequent dot product operation. Then, two 512-bit vectors x_pe5m2 and y_pe5m2 are loaded. These vectors are populated using the _mm512_loadu_pfp8 function with data from src1 and src2 respectively. The vectors hold the FP8(E5M2) format data which will be used for the dot product operation.

Subsequently, the shared scale terms for the operation are set using the _scale64_genscales function. This function combines the scale terms from src1_scale and src2_scale and stores them into the scales register, a 64-bit register. The first 32 bits of this register are relevant to the FP8 dot product operation.

Finally, the dot product operation is performed implicitly using the scales that have been set. The _mm512_dpe5m2e5m2_ps function is used for this operation. It performs a quad-wise dot product operation on the two 512-bit vectors of FP8(E5M2) format data, scales the result using the data in the scales register, and accumulates the results into the dst_ps vector.

Code listing 800 in FIG. 8 demonstrates a method of executing a dot product operation using shared scale terms implicitly read from the processor state. This approach optimizes the operation by reducing the number of required operands and allows for direct computation using a denser numerical format.

The implementation shown in FIG. 8 introduces two new intrinsics, _scale64_genscales and _mm512_dpe5m2e5m2_ps, to streamline the dot product operation. The first intrinsic, _scale64_genscales, serves to combine src1_scale and src2_scale into a process state register referred to as DP_SCALE. The second intrinsic, _mm512_dpe5m2e5m2_ps, performs a quad-wise dot product operation on two 512-bit vectors of FP8(E5M2) format data, scaling the operation using the data stored in DP_SCALE, and accumulates the result in the vector dst_ps.

As mentioned above, in some examples, one or more of modules 102 (e.g., loading module 104, storing module 106, and/or vector operation module 108) may perform a conversion operation that converts the pair of input vectors from a first floating-point format (e.g., one or more MX formats) to a second floating-point format (e.g., BF16).

As described above, the AVX-512 ISA provides dot product primitives for BF16 and integer data types. These primitives generally consume two vectors of BF16 format data, multiplies pairs, and accumulates them into FP32 destination lanes. The way these operations are used may depend on requirements of a higher-level algorithm. For instance, it may be possible to accumulate different points in the matrix in the different lanes. Embodiments of the present disclosure offer flexibility in handling such operations, adapting to the specific needs of the computational task at hand.

Hence, in some embodiments, the systems and methods disclosed herein may provide a dot product operation for MX format data. This process may involve reusing the existing dot product operation and converting Pᵢ terms from MX to BF16, a new operation. After this, a BF16 dot product is performed, followed by the application of shared scale terms, another new operation. Finally, the results are accumulated with an accumulator vector. This approach offers a potential route for optimizing dot product operations within the MX format.

Hence, one or more of modules 102 may perform a conversion operation that converts the pair of input vectors from a first floating-point format (e.g., an MX format) to a second floating-point format (e.g., BF16) by sequentially applying a plurality of shared scale terms to corresponding input vectors via a register wider than the plurality of shared scale terms, the register configured to shift the plurality of shared scale terms to position a next shared scale term for application in a subsequent conversion.

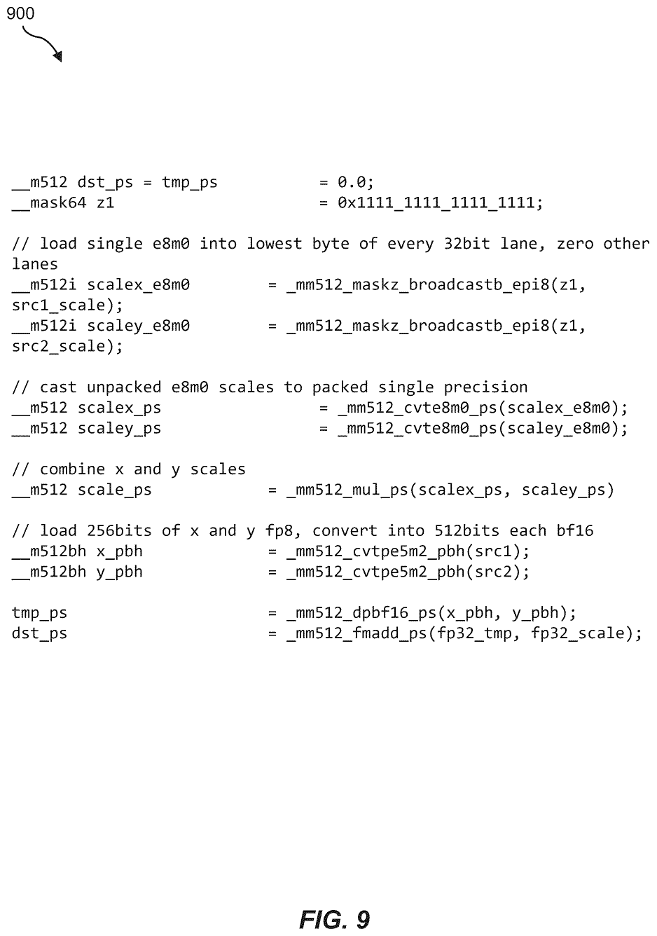

FIG. 9 includes a code listing 900 that represents a practical implementation of a dot product using VDPBF16PS in accordance with some embodiments. The code describes a process of optimizing a dot product operation for MX format data, using the AVX-512 ISA.

The code in code listing 900 initializes two 512-bit variables, dst_ps and tmp_ps, to zero. The variable z1 is a 64-bit mask set to a specific value. Then it loads a single E8M0 (exponent of 8 bits, mantissa of 0 bits) into the lowest byte of every 32-bit lane, zeroing the other lanes. The loading operation is carried out for two scales, src1_scale and src2_scale, using the _mm512_maskz_broadcastb_epi8 function, and the results are stored in scalex_e8m0 and scaley_e8m0.

Next, the code casts the unpacked E8M0 scales to packed single precision format using the _mm512_cvte8m0_ps function. The result of the casting operation for both scalex_e8m0 and scaley_e8m0 is stored in scalex_ps and scaley_ps. The scalex_ps and scaley_ps are combined using a multiplication operation, and the result is stored in scale_ps.

The code then loads 256 bits of x and y in MXFP8 format and converts them into 512 bits of BF16 each using the _mm512_cvtpe5m2_pbh function. The results are stored in x_pbh and y_pbh. The code performs a dot product operation on x_pbh and y_pbh using the _mm512_dpbf16_ps function and stores the result in tmp_ps.

Finally, the code performs a fused multiply-add (FMA) operation on tmp_ps and fp32_scale, and stores the result in dst_ps. This last step applies the shared scale terms to the dot product and accumulates the result into the accumulator vector. This operation is part of the process to improve the efficiency and optimization of the dot product operation for MX format data.

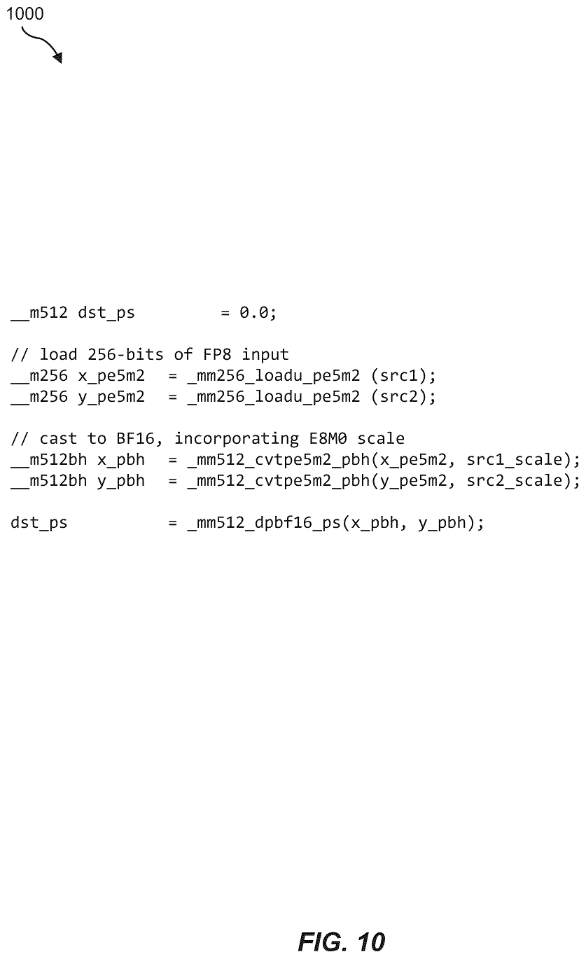

FIG. 10 includes a listing 1000 that illustrates that the E8M0 encoding makes multiplication by shared scale terms effectively an exponent adjustment rather than a full multiplication. The code listing 1000 in FIG. 10 demonstrates the process of casting MXFP8 input to BF16 while incorporating E8M0 scale, and then performing a dot product operation. This process is part of a method for optimizing the dot product operation for MX format data. The code starts by initializing a 512-bit variable, dst_ps, to zero. It then loads 256-bits of MXFP8 input for two different variables, src1 and src2, using the _mm256_loadu_pe5m2 function. The loaded input is stored in x_pe5m2 and y_pe5m2.

Next, the code casts the MXFP8 input to BF16 while incorporating the E8M0 scale. This is done using the _mm512_cvtpe5m2_pbh function, which converts 256 bits of MXFP8 data into BF16, combining it with a single e8m0 scale term in the process. The results of these casting operations are stored in x_pbh and y_pbh.

Finally, the code performs a dot product operation on x_pbh and y_pbh using the _mm512_dpbf16_ps function, accumulating and storing the result in dst_ps. Depending on the instruction encoding selected, the 8-bit scale term could be located in a general-purpose register (GPR), the bottom lane of a vector, or in memory.

By performing the scaling in line with the conversion of Pᵢ terms to BF16 format, the code achieves several improvements over the previous listing. Firstly, there is no need for a temporary register to hold the output of the VDPBF16 operation. Secondly, it eliminates the need to combine the two scale terms before applying them within the post-dot product scale. As a result, this code listing 1000 is significantly more efficient than that of code listing 900.

In an additional example the scale term used in the _mm512_cvtpe5m2_pbh operation may be derived from a register that is wider than 8-bits, such as a 64-bit GPR or a 512-bit vector register. This conversion operation is designed to read the lower 8-bits (or 9-bits in one embodiment) of the register, using it as the scale term and ignoring the remaining bits. The code loads multiple scale terms into the register, arranging them so that the next scale term to be used is positioned in the bottom element of the register.

In one embodiment, two registers are allocated for this purpose, one for each vector input to the dot product operation. In another embodiment, a new instruction is defined to combine two vectors of scale terms into a single register. Each element in this register represents the multiplication of the corresponding e8m0 scale terms. This approach reduces the number of registers being allocated.

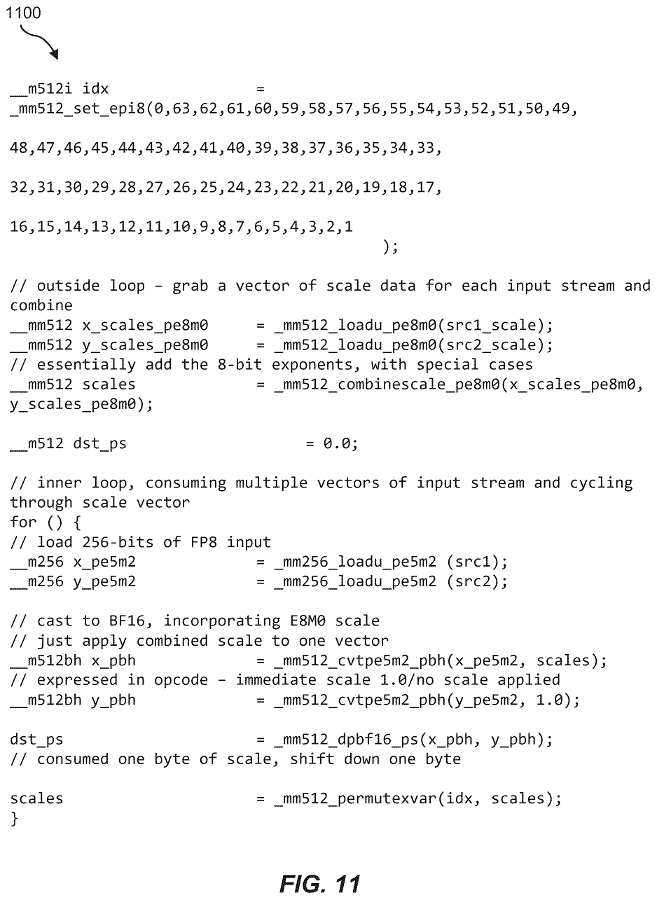

In this embodiment, the combined scale is applied to only one vector input to the dot product. The _mm512_cvtpe5m2_pbh operation is expanded with an opcode select to enable the scale to be consumed from a register or to apply a constant 1.0 scale. The summation operation provides two options: the combined result for each element in the vector could either be another E8M0 encoded number (which may lose a bit of precision before application to the dot product result) or an E9M0 number that preserves precision. The elements may likely be arranged in 16-bit containers, although bit packing is also an option. Listing 1100 in FIG. 11 demonstrates an optimized approach to handling the dot product operation for MX format data using the AVX-512 ISA. This code listing illustrates an additional strategy for efficient conversion, scale application, and summation.

Initially, the code sets an index register with a specific sequence of values from 0 to 63. Then, it loads a vector of scale data for each input stream outside the loop and combines them. This combination is achieved by essentially adding the 8-bit exponents from the _mm512_loadu_pe8m0 function, accounting for special cases, and storing the result in the scales variable. A 512-bit variable dst_ps is also initialized to zero at this point.

The main part of the operation happens inside a loop, which processes multiple vectors of input stream and cycles through the scale vector. In each iteration, the code loads 256-bits of MXFP8 input for two variables. It then casts this data to BF16, incorporating the E8M0 scale. The _mm512_cvtpe5m2_pbh function is used for this purpose, applying the combined scale to only one vector and leaving the other vector with no scale applied or a 1.0 immediate scale. Then, a dot product operation is performed on the two vectors, and the result is stored in dst_ps.

After the dot product operation, the code consumes one byte of scale and shifts it down by one byte. This shift operation is performed using the _mm512_permutexvar function, with the previously set index register. The loop continues to iterate, processing multiple vectors of input stream and adjusting the scale accordingly.

By implementing a dot product for MX format data through the reuse of an existing dot product operation and introducing new operations such as _mm512_cvte8m0_ps and _mm512_cvtpe5m2_pbh, these embodiments effectively handle MX formats using the AVX-512 ISA.

Moreover, the incorporation of scale into format conversion and the optimization of scale term traffic have been introduced to improve efficiency, particularly in terms of bandwidth to L1 data cache and register resource usage. Notably, even though the focus has been primarily on conversion to BF16 format, these embodiments can equally apply to operations that convert to FP32, thereby offering a more versatile and efficient solution for handling AI workloads.

As discussed throughout the instant disclosure, the disclosed systems and methods may provide one or more advantages over traditional options for execution of vector operations.

The instant disclosure presents a series of innovative techniques designed to enhance the efficiency and performance of machine learning computations by leveraging MX formats. These formats are particularly tailored for AI workloads and offer significant advantages in terms of storage and compute density when compared to traditional atomic data formats such as BF16.

Some of the overarching benefits provided by embodiments of the systems and methods disclosed herein may include increased compute efficiency. By optimizing dot product operations for MX formats, the disclosed methods allow for faster and more efficient computations, which is critical for the performance-intensive requirements of AI and machine learning tasks. Additionally, embodiments of the systems and methods disclosed herein may lead to better utilization of memory hierarchy, providing an advantage in scenarios where memory bandwidth and space are at a premium.

Moreover, the disclosed methods are designed to be integrated with the current AVX-512 instruction set extension, ensuring that they can be adopted without the need for radical changes to existing hardware or software infrastructures. The disclosed techniques may also reduce the complexity of operations by minimizing the number of operands and simplifying the handling of shared scale terms, making it easier to implement and optimize machine learning algorithms.

Additionally, while the focus has been on MX formats and their conversion to BF16, the disclosed methods are versatile and could potentially be applied to other conversions, such as to FP32, highlighting the adaptability of the inventions to a range of computational scenarios.

Hence, the present disclosure provides a suite of methods and systems that collectively represent a significant step forward in the field of machine learning computations, delivering enhanced performance, reduced complexity, and better memory efficiency through intelligent design and integration with existing computational paradigms. Further, the disclosed systems and methods may be forward-compatible or adaptable to future advancements in processing architectures.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive MX format data to be transformed, transform the MX format data, output a result of the transformation to execute a vector function, use the result of the transformation to perform an additional vector function, and store the result of the transformation to present an output of the vector function. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems. Hence, in some examples, a non-transitory computer readable medium may have encoded thereon executable instructions that, when executed by at least one processor, cause the at least one processor to carry out one or more operations.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
loading a pair of input vectors into a respective pair of registers included in a processor, each input vector associated with a different shared scale term;
storing a shared scale term corresponding to at least one of the pair of input vectors within at least one control register of the processor; and
performing a vector operation that utilizes the pair of input vectors by accessing the at least one control register to retrieve the shared scale term as part of the vector operation.

2. The method of claim 1, further comprising:
storing the shared scale term corresponding to each of the pair of input vectors by loading the shared scale term associated with a first of the pair of input vectors into a predicate mask register and loading the shared scale term associated with a second of the pair of input vectors into the predicate mask register; and
performing the vector operation by accessing the predicate mask register to retrieve shared scale terms as part of a dot product operation.

3. The method of claim 1, further comprising:
combining the shared scale terms associated with the pair of input vectors into a combined shared scale term;
formatting the combined shared scale term; and
one of:
placing the combined shared scale term in a single predicate mask register; or
storing the combined shared scale term into a general register;
wherein the vector operation utilizes the pair of input vectors by accessing, to retrieve the combined shared scale term as part of the vector operation, one of:
the single predicate mask register; or
the general register.

4. The method of claim 1, further comprising:
storing the shared scale term corresponding to at least one of the pair of input vectors by storing the shared scale term in a processor state register; and
performing the vector operation by defining a dot product operation to implicitly access the shared scale term from the processor state register as part of the dot product operation.

5. The method of claim 1, further comprising performing a conversion operation that converts the pair of input vectors from a first floating-point format to a second floating-point format by sequentially applying a plurality of shared scale terms to corresponding input vectors via a register having a width sufficient to hold more than one of the plurality of shared scale terms, the register configured to shift the plurality of shared scale terms to position a next shared scale term for application in a subsequent conversion.

6. The method of claim 1, further comprising loading the pair of input vectors into the pair of registers included in the processor, the pair of input vectors encoded in a first floating-point format and the pair of registers configured for a second floating-point format.

7. The method of claim 6, wherein each of the pair of registers configured for the second floating-point format is at least 512-bits wide.

8. The method of claim 6, wherein each of the pair of registers configured for the second floating-point format is configured to store an operand for an Advanced Vector Extensions 512 (AVX-512) instruction.

9. The method of claim 6, wherein the first floating-point format is a MicroXcaling (MX) format.

10. The method of claim 9, wherein each of the pair of input vectors of the first floating-point format have a different MX format.

11. The method of claim 9, wherein the MX format is selected from a group consisting of Floating-Point 8-bit, Floating-Point 6-bit, Floating-Point 4-bit, and Integer 8-bit.

12. The method of claim 9, further comprising synthesizing a dot product by loading and accumulating multiple blocks of MX format data.

13. The method of claim 9, further comprising synthesizing a matrix multiplication by consuming and accumulating multiple blocks of MX format data.

14. The method of claim 1, wherein each input vector has at least 32 elements.

15. The method of claim 1, wherein the shared scale term is applied to a summation term prior to an accumulation during the vector operation.

16. The method of claim 1, further comprising accumulating, as part of the vector operation, directly into a destination accumulation vector register having a different floating-point format from a floating-point format of the input vectors.

17. A system for efficient execution of vector operations, comprising:
a processor comprising:
a pair of registers configured to store input vectors, each input vector being associated with a shared scale term; and
at least one control register configured to store the shared scale term corresponding to at least one of the input vectors;
wherein the processor is configured to:
load a pair of input vectors into the respective pair of registers;
store the shared scale term in the at least one control register; and
perform a vector operation using the pair of input vectors, wherein the vector operation accesses the at least one control register to retrieve the shared scale term.

18. The system of claim 17, wherein the processor further comprises:
a predicate mask register configured to store shared scale terms corresponding to each of the input vectors; and
circuitry configured to perform the vector operation by accessing the predicate mask register to retrieve the shared scale terms and execute a dot product operation.

19. The system of claim 17, wherein the processor further comprises:
a predicate mask register configured to store shared scale terms corresponding to each of the input vectors; and
circuitry configured to perform the vector operation by accessing the predicate mask register to retrieve the shared scale terms and execute a dot product operation.

20. A system comprising:
at least one non-transitory computer-readable storage medium having encoded thereon executable instructions;
a processor configured to execute the instructions, wherein execution of the instructions causes the processor to:
load a pair of input vectors into a respective pair of registers included in the processor, wherein each input vector is associated with a shared scale term;
store the shared scale term corresponding to at least one of the input vectors in at least one control register of the processor; and
perform a vector operation using the pair of input vectors, wherein the vector operation retrieves the shared scale term by accessing the shared scale term from the at least one control register.
